(19) United States
(12) Patent Application Publication
(10) Pub. No.: US 2018/0285844 A1
(43) Pub. Date: Oct. 4, 2018

(54) AUTOMATED TELLER MACHINE TRANSACTION PREMIUM LISTING TO PREVENT TRANSACTION BLOCKING

(71) Applicant: Mastercard International Incorporated, Purchase, NY (US)

(72) Inventors: Denise Schroder, Creve Coeur, MO (US); Dawn Strohbach, Wentzville, MO (US); Kirk Menard, Wentzville, MO (US); Brenda Hopkins, Wildwood, MO (US); Mark B. Wiesman, Chesterfield, MO (US)

(73) Assignee: Mastercard International Incorporated, Purchase, NY (US)

(21) Appl. No.: 15/987,696

(22) Filed: May 23, 2018

Related U.S. Application Data
(63) Continuation of application No. 14/050,818, filed on Oct. 10, 2013.
Application No. 14/050,818 is a continuation-in-part of application No. 13/748,939, filed on Jan. 24, 2013.

(51) Int. Cl. G06Q 20/10; G06Q 20/40

(52) U.S. Cl. CPC G06Q 20/1085; G06Q 20/405; G06Q 20/4016

(57) ABSTRACT

A system, method, and computer-readable storage medium configured to store a premium list of accounts of ATM cardholders, wherein the list includes primary account numbers (PANs) associated with the accounts of the ATM cardholders, and to allow the ATM transaction to proceed unblocked if the PAN of the transaction appears on the premium list even if the transaction would otherwise be blocked by the controller based on one or more fraud prevention rules.

### RELATED APPLICATIONS

The is a continuation of application Ser. No. 14/050,818, filed Oct. 10, 2013, which is a continuation-in-part of U.S. application Ser. No. 13/748,939 filed Jan. 24, 2013, both of which are fully incorporated herein by reference.

### BACKGROUND

### Field of the Disclosure

Aspects of the disclosure relate in general to financial services. Aspects include an apparatus, a method and system for providing a decision making platform for processing transactions involving Automated Teller Machine (ATM) cards, and more particularly to a network-based system and method that provide a computer-related platform for decision making based on an accessibility to multiple transaction scoring engines, at least a portion of the scoring engines determining fraud risk for transactions involving ATM cards.

### Description of the Related Art

An Automated Teller Machine (ATM) card (also known as a bank card, client card, key card, or cash card) is a card issued by a financial institution, such as a bank, credit union, or building society that can be used in an Automated Teller Machine. The Automated Teller Machine provides the clients of a financial institution with access to financial transactions in a public space without the need for a cashier, human clerk or bank teller. Such transactions include deposits, cash withdrawals, and obtaining account information.

In a typical transaction, customers use an Automated Teller Machine to withdraw cash from their account.

It can also be used on improvised ATMs, such as merchants' card terminals that deliver ATM features without any cash drawer (commonly referred to as mini ATMs). These terminals can also be used as cashless scrip ATMs by cashing the fund transfer receipt at the merchant's Cashier.

ATM cards have made great gains in the United States as a means to attract financial accounts and generate fees for financial institutions.

However, ATM cards are also subject to a variety of financial card fraud. At least one Automated Teller Machine card network currently provides fraud scoring for Automated Teller Machine card transactions. Fraud scoring refers to an indication, or likelihood, that an ATM transaction is fraudulent. In one fraud scoring system, the Automated Teller Machine card network provides a number back to the Automated Teller Machine card issuer between zero and 1,000, which translates into zero and 100 percent, in tenths of percentage points. To provide fraud scoring capability, various vendors or Automated Teller Machine card companies provide and market various different fraud scoring products. An Automated Teller Machine card company generally selects one of the vendor products to provide its customers (the card issuers) with one of fraud scoring and credit risk scoring that is accessible, for example, on an Automated Teller Machine card network.

### SUMMARY

Embodiments include an ATM transaction decision system located at a processing network, wherein the system comprises a network interface configured to receive data of an ATM transaction from a merchant bank, wherein the ATM transaction data includes a primary account number (PAN) associated with a cardholder. The system further comprises an ATM premium listing service module running on a processor, wherein the ATM premium listing service module is configured to generate a premium list of accounts of ATM cardholders, wherein the list includes PANs associated with the accounts of the cardholders. The system further comprises a controller running on a processor, wherein the controller is configured to allow the ATM transaction to proceed unblocked if the PAN of the transaction appears on the premium list even if the transaction would otherwise be blocked by the controller based on one or more fraud prevention rules.

Embodiments also include a method of processing an ATM transaction at a processing network, wherein the method comprises generating a premium list of accounts of ATM cardholders, wherein the list includes PANs associated with the accounts of the cardholders. The method further comprises receiving, via a computer network, data of an ATM transaction from a merchant bank, wherein the ATM transaction data includes a PAN associated with a cardholder and allowing the ATM transaction to proceed unblocked if the PAN of the transaction appears on the premium list even if the transaction would otherwise be blocked based on one or more fraud prevention rules.

Embodiments also include a computer-readable medium encoded with data and instructions, when executed by a computing device the instructions cause the computing device to generate a premium list of accounts of ATM cardholders, wherein the list includes PANs associated with the accounts of the cardholders. The instructions further causes the computing device to retrieve, from a database, data of an ATM transaction from a merchant bank, wherein the ATM transaction data includes a PAN associated with a cardholder, and allow the ATM transaction to proceed unblocked if the PAN of the transaction appears on the premium list even if the transaction would otherwise be blocked based on one or more fraud prevention rules.

### BRIEF DESCRIPTION OF THE DRAWINGS

FIG. 1 is a flowchart illustrating a ATM financial transaction using an ATM Automated Teller Machine card network.

FIG. 2 is a simplified block diagram of an exemplary embodiment of a server architecture of a system in accordance with one embodiment.

FIG. 3 is an expanded block diagram of an exemplary embodiment of a server architecture of a system in accordance with one embodiment.

FIG. 4 is an architectural diagram of a decision platform in accordance with one embodiment.

FIG. 5 is a diagram illustrating a logical architecture for the decision platform of FIG. 4.

FIG. 6 is a logical architecture diagram for a flexible transaction processor included within the decision platform of FIG. 4.

FIG. 7A is a first portion of a class structure diagram for the input channels of the flexible transaction processor of FIG. 6.

FIG. 7B is a second portion of the class structure diagram for the input channels of the flexible transaction processor of FIG. 6.

FIG. 8 is a class structure diagram illustrating internal message object formats utilized with the flexible transaction processor of FIG. 6.

FIG. 9 is a class structure diagram illustrating transaction objects for abstract classes and sub-classes utilized with the flexible transaction processor of FIG. 6.

FIG. 10 is a class structure diagram illustrating input channel object subclasses by specific input adaptors that are utilized with the flexible transaction processor of FIG. 6.

FIG. 11 is a class structure diagram illustrating the transaction filter services used by the flexible transaction processor of FIG. 6.

FIG. 12A is a first portion of a class structure diagram for the output channels of the flexible transaction processor of FIG. 6.

FIG. 12B is a second portion of the class structure diagram for the output channels of the flexible transaction processor of FIG. 6.

FIG. 13 illustrates a fraud prevention rule in which a withdrawal is prevented because the transaction amount exceeds a predetermined amount.

FIG. 14 illustrates a fraud prevention rule in which a withdrawal is prevented because total transaction amount exceeds a predetermined amount within a time period.

FIG. 15 illustrates a fraud prevention rule in which a withdrawal is prevented because the total number of transactions exceeds a predetermined amount within a time period.

FIG. 16 is a logical architecture diagram further including an ATM premium listing service module for the flexible transaction processor of FIG. 6.

FIG. 17 illustrates an example of a process to unblock ATM transactions based on a premium list of accounts of cardholders.

### DETAILED DESCRIPTION

One aspect of the disclosure includes the realization that each of the various vendor scoring products generally provides at least one advantage when compared to other scoring products. Accordingly, a system and method includes an Automated Teller Machine card network to combine more than one of the above mentioned vendor fraud scoring products together to provide value added services to their customers. Further, such a system and method should be easily configurable to allow the user to easily utilize various combinations of these products. In such a system, the Automated Teller Machine card network operators should be able to easily integrate vendor products and orchestrate scoring across many of these products, combine the various scores and return those scores back to customers through a variety of output channels.

While many companies implement a single fraud scoring engine, the described decision system embodiments provide a highly flexible platform that facilitates scoring and/or rules implementation across multiple scoring engines. In addition, the described platform provides a plug and play type architecture with the technical effect of integrating these vendor fraud scoring products with pluggable input sources (e.g., input channels) and output delivery mechanisms. The following paragraphs describe the linking together of these various components into an overall comprehensive decision system, or platform. Implementation of such a system features a flexible, work flow based approach for accessing component plug-ins.

In one example, MasterCard's Authorization Service Architecture (ASA) provides for the transfer and reception of Automated Teller Machine card transaction data in real time. If the Automated Teller Machine card is used at a merchant (swiped), the transaction data is sent to the merchant's bank called the acquirer bank. In one practical example, the transaction data is then sent over Banknet® (Banknet is a registered trademark of MasterCard International Incorporated, Purchase, N.Y.) to the ASA and on to the system for scoring. Upon generation of a score, that score is sent back through the ASA and onto the Automated Teller Machine card issuer where they approve or decline the proposed transaction, taking into account the scoring provided from the Automated Teller Machine card network. Stated more simply, the issuer can take into account fraud scores, in real-time, to approve or decline transactions. The described embodiments relate to an architecture that provides a type of plug and play capability for the incorporation of multiple transaction scoring engines.

In use, the Automated Teller Machine card network receives messages containing transaction data at which point it is determined how to process the data. For example, some preprocessing might be done to enrich, transform, and filter the transaction data as described herein. Other customers (e.g., card issuers) may only want certain types of transaction scores, such as those coming from high risk merchants.

Another component of the described embodiments relates to case management. When a transaction scores high, in terms of fraud or risk, the card issuer may decide to open a case for further investigation. The described embodiments allow a user to plug in different vendor provided case management solutions. From the customer (card issuer) perspective, they are able to report or access new reporting on their data or directly access the case management system.

The described embodiments relate to making each piece of the described decision platform such as the input, scoring, case management, and output pluggable. Multiple plug-ins can be incorporated for the pre-processing of transaction data, for example, to provide one or more of filtering, transformation, data enrichment, etc.

In one embodiment, a computer program is provided, and the program is embodied on a computer readable medium and utilizes a Structured Query Language (SQL) with a client user interface front-end for administration and a web interface for standard user input and reports. In an exemplary embodiment, the system is web enabled and is run on a business-entity intranet. In yet another embodiment, the system is fully accessed by individuals having an authorized access outside the firewall of the business-entity through the Internet. In yet another embodiment, the system is run on a mainframe environment and a UNIX® server environment (UNIX is a registered trademark of AT&T, New York, N.Y.). In a further exemplary embodiment, the system is being run in a Windows® environment (Windows is a registered trademark of Microsoft Corporation, Redmond, Wash.). The application is flexible and designed to run in various different environments without compromising any major functionality.

The systems and processes are not limited to the specific embodiments described herein. In addition, components of each system and each process can be practiced independent and separate from other components and processes described herein. Each component and process also can be used in combination with other assembly packages and processes.

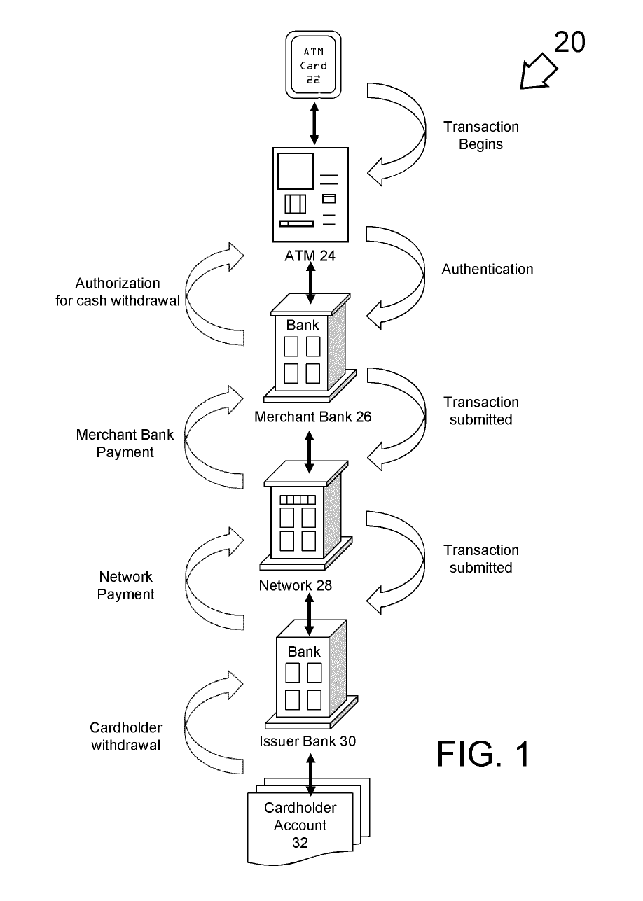

FIG. 1 is a flowchart 20 illustrating a typical Automated Teller Machine financial transaction using an Automated Teller Machine card payment system. The present disclosure is related to an Automated Teller Machine card payment system, such as a credit card payment system using the MasterCard® interchange, Cirrus® network, or Maestro®. The MasterCard interchange is a proprietary communications standard promulgated by MasterCard International Incorporated for the exchange of financial transaction data between financial institutions that are customers of MasterCard International Incorporated. Cirrus is a worldwide interbank network operated by MasterCard International Incorporated linking debit and prepaid cards to a network of ATMs throughout the world. Maestro is a multi-national debit card service owned by MasterCard International Incorporated.

In an Automated Teller Machine financial payment system, a financial institution called the “issuer” issues an Automated Teller Machine card to a consumer, who uses ATM card to tender payment for a purchase from a merchant or withdraw cash from an Automated Teller Machine. In this example, a user presents the ATM card to an ATM affiliated with a financial institution. This financial institution is usually called the “merchant bank” or the “acquiring bank” or “acquirer bank.” When an ATM card 22is tendered at an Automated Teller Machine 24, the Automated Teller Machine 24 electronically requests authorization from the merchant bank 26 for the amount of the purchase. The request is performed electronically with the consumer's account information from the magnetic stripe on the ATM card or via a computer chip imbedded within the card. The account information is forwarded to transaction processing computers of the merchant bank. Alternatively, a merchant bank may authorize a third party to perform transaction processing on its behalf. In this case, the Automated Teller Machine will be configured to communicate with the third party. Such a third party is usually called a “merchant processor” or an “acquiring processor.”

Using a processing network 28, the computers of the merchant bank or the merchant processor will communicate with the computers of the issuer bank 30 to determine whether the consumer's account is in good standing and whether the cash withdrawal is covered by the consumer's available account balance. Based on these determinations, the request for authorization will be declined or accepted. If the request is accepted, an authorization code is issued to the merchant.

When a request for authorization is accepted, the available account balance of cardholder's account 32 is decreased.

After a transaction is captured, the transaction is settled between the merchant, the merchant bank, and the issuer. As described herein, the term “Automated Teller Machine card” includes cards such as debit cards, but also includes any other devices that may hold payment account information, such as mobile phones, personal digital assistants (PDAs), and key fobs.

In embodiments of the current disclosure, processing network 28 is able to preemptively reject ATM transactions based on rules, without seeking authorization from the issuer bank 30. As will be described below, these rules may eliminate potential fraudulent transactions from occurring.

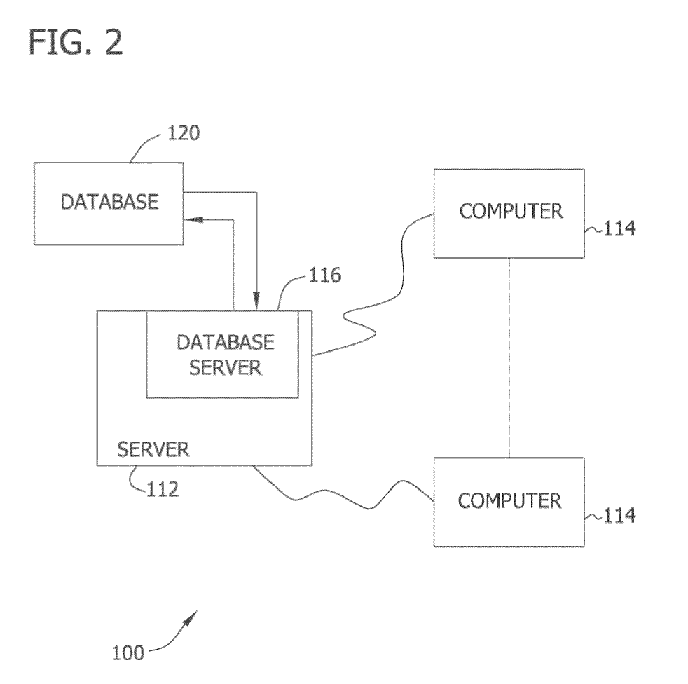

FIG. 2 is a simplified block diagram of an exemplary system 100 in accordance with one embodiment. In this embodiment, system 100 is the Automated Teller Machine card payment system shown in FIG. 1, which can be utilized for providing a decision making platform. More specifically, in the example embodiment, system 100 includes a server system 112, and a plurality of client sub-systems, also referred to as client systems 114, connected to server system 112. In one embodiment, client systems 114 are computers including a web browser, such that server system 112 is accessible to client systems 114 using the Internet. Client systems 114 are interconnected to the internet through many interfaces including a network, such as a local area network (LAN) or a wide area network (WAN), dial-in-connections, cable modems and special high-speed ISDN lines. Client systems 114 could be any device capable of interconnecting to the Internet including a web-based phone, personal digital assistant (PDA), or other web-based connectable equipment. A database server 116 is connected to a database 120 containing information on a variety of matters, as described below in greater detail. In one embodiment, centralized database 120 is stored on server system 112 and can be accessed by potential users at one of client systems 114 by logging onto server system 112 through one of client systems 114. In an alternative embodiment, database 120 is stored remotely from server system 112 and may be non-centralized.

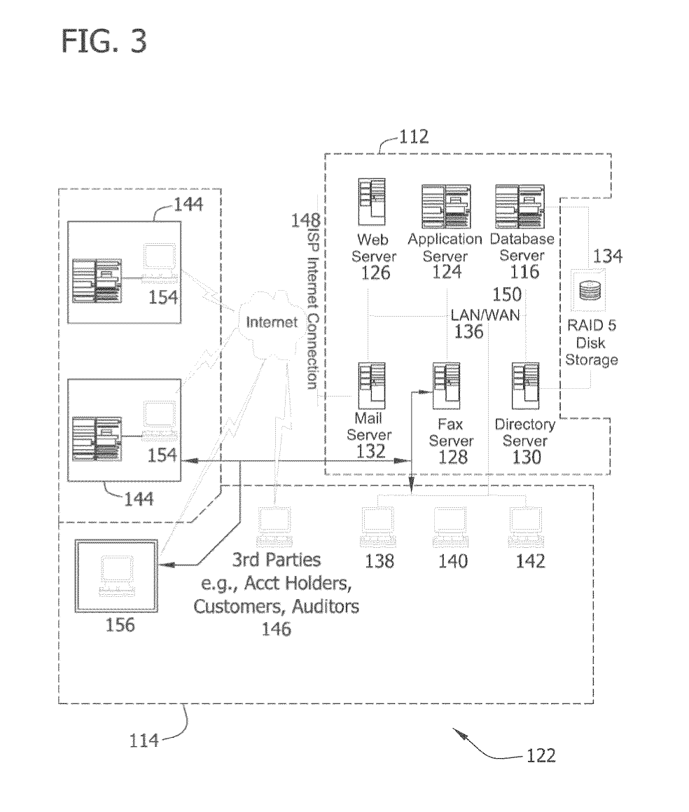

FIG. 3 is an expanded block diagram of an exemplary embodiment of a server architecture of a system 122 in accordance with one embodiment of the present disclosure. Components in system 122, identical to components of system 100 (shown in FIG. 2), are identified in FIG. 3 using the same reference numerals as used in FIG. 2. System 122 includes server system 112 and client systems 114. Server system 112 further includes database server 116, an application server 124, a web server 126, a fax server 128, a directory server 130, and a mail server 132. A disk storage unit 134 is coupled to database server 116 and directory server 130. Servers 116, 124, 126, 128, 130, and 132 are coupled in a local area network (LAN) 136. In addition, a system administrator's workstation 138, a user workstation 140, and a supervisor's workstation 142 are coupled to LAN 136. Alternatively, workstations 138, 140, and 142 are coupled to LAN 136 using an Internet link or are connected through an Intranet.

Each workstation, 138, 140, and 142 is a personal computer having a web browser. Although the functions performed at the workstations typically are illustrated as being performed at respective workstations 138, 140, and 142, such functions can be performed at one of many personal computers coupled to LAN 136. Workstations 138, 140, and 142 are illustrated as being associated with separate functions only to facilitate an understanding of the different types of functions that can be performed by individuals having access to LAN 136.

Server system 112 is configured to be communicatively coupled to various individuals, including employees 144 and to third parties, e.g., auditors, 146 using an ISP Internet connection 148. The communication in the exemplary embodiment is illustrated as being performed using the Internet, however, any other wide area network (WAN) type communication can be utilized in other embodiments, i.e., the systems and processes are not limited to being practiced using the Internet. In addition, and rather than WAN 150, local area network 136 could be used in place of WAN 150.

In the exemplary embodiment, any authorized individual having a workstation 154 can access system 122. At least one of the client systems includes a manager workstation 156 located at a remote location. Workstations 154 and 156 are personal computers having a web browser. Also, workstations 154 and 156 are configured to communicate with server system 112. Furthermore, fax server 128 communicates with remotely located client systems, including a client system 156 using a telephone link. Fax server 128 is configured to communicate with other client systems 138, 140, and 142 as well.

The described embodiments provide application of real-time fraud prediction rules and/or scoring of authorization messages from an acquirer prior to the forwarding of those messages to the ATM card issuer, and to introduce fraud management into the criteria used by a transaction card issuer when accepting or declining a transaction request. The described decision system and its associated methods provide an important market differentiator for a user in the area of fraud and risk management. At least one differentiator occurs in the area of real-time application of fraud prevention rules applied to ATM transactions. Specifically, the decision system enables the use of fraud prediction information as part of the criteria used by transaction card issuers when processing transaction requests. Another differentiator occurs in the area of customization of fraud prediction models. Specifically, the decision process provides services not currently provided in that the creation of real-time fraud prediction models customized for a specific population of fraud patterns is enabled at a greater level of granularity than those currently provided. Custom fraud prediction models are executed using embedded environment instances. These models calculate fraud prediction scores using multiple artificial intelligence and other technologies, such as neural networks, case-based reasoning system, data mining, and fuzzy logic.

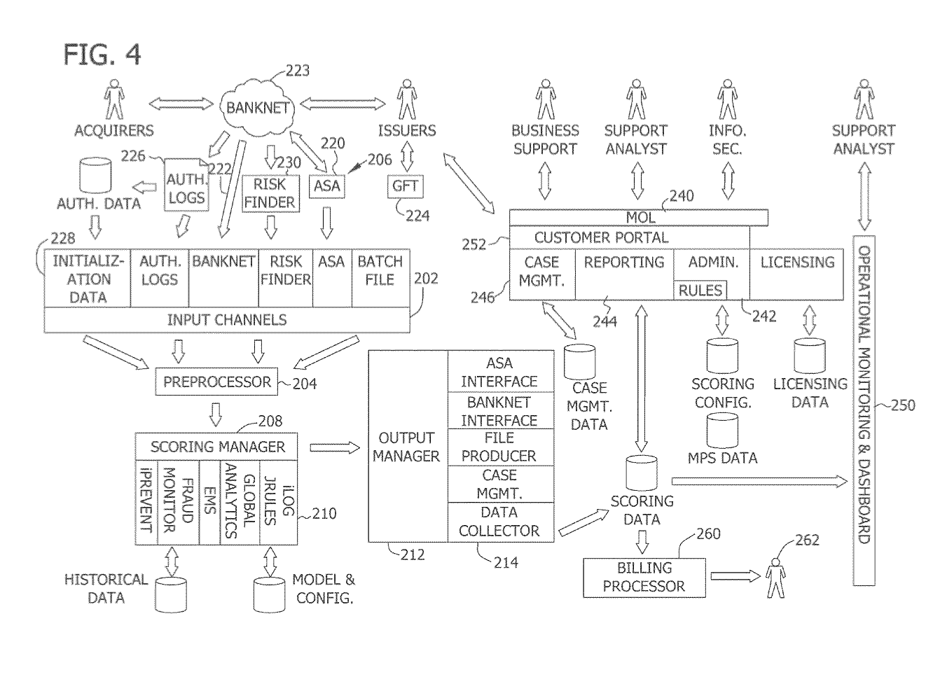

To support the above described real-time fraud prevention rules and prediction scoring of authorization messages from an acquirer, using multiple scoring engines, FIG. 4 is an architectural diagram of a decision platform 200. The decision platform 200, at a high level, includes a plurality of input channels 202 that provide transaction data to a preprocessor 204. In various specific embodiments, the decision system 200 receives input transactions 206 from a variety of input channels 202. The preprocessor 204 combines the data from the various input channels 202 and provides the combined data to a scoring manager 208. Scoring manager 208 is configured to apply rules to and/or score transactions. Preprocessing logic within preprocessor 204 transforms, filters, and enriches the received financial card transaction data. The transaction data is then scored by various scoring engines 210 which operate under the control of the scoring manager 208.

The resulting ruled/scored transactions are filtered by an output manager 212 and delivered to users of such data via a variety of output channels 214 in appropriate formats. Transaction processing is highly flexible since an ability to easily customize, an ability to plug in new components (e.g., input channels, output channels, transformations, filters, etc.), and an ability to plug in best of breed products are all provided via the architecture of decision system 200. In addition, the decision system 200 provides business intelligence to improve future decision making capability.

Referring again to the input channels 202, the decision system 200 provides for the ability to score transactions from input channels 206, several of which are described below. With respect to ASA 0100 authorization messages 220, for configured account ranges, the decision system 200 sends 0100 messages to be scored in real time prior to delivery to an issuer.

Another input channel is an authorization logs 226 input channel. For scenarios where the original transaction was sent on Banknet 223 and not scored, the system 200 uses the authorization log transactions 226 to score any previously un-scored transaction, providing the account activity “velocity counters” with a complete picture of activity. In addition, the resulting scored transactions may be provided via an output channel 214. Initialization data 228 refers to the boarding of new customers. For these customers, historical transaction data (initialization data) is fed into the system 200.

As mentioned above, transactions from the various input channels 202 are routed to the scoring manager 208 which provides format transformation, transaction filtering, data augmentation and routing to the appropriate scoring engine. For example and referring to FIG. 4, several scoring engines are shown, wherein each of the scoring engines is utilized to rate a transaction and generate a score for the transaction that reflects its fraud likelihood. For non-limiting examples, such scoring engines include but are not limited to the Brighterions™ iPrevent™ scoring engine, Fraud Mark's Fraud Monitor scoring engine, EMS (MasterCard's Expert Monitoring System), Global Analytics scoring engine, and iLog™ JRules rules engine. The scoring manager 208 routes the transaction to the appropriate scoring engines 210. For each scoring engine 210, the scoring manager 208 performs the required message transformations and communicates with the engine 210 to score the transaction. For example, one scoring engine 210 uses a fraud prediction model to determine a score between 1 (least likely to be fraud) and 998 (most likely to be fraud) for the transaction. This scoring engine is initialized from a model file and a database. The fraud prediction model keeps track of account usage patterns, also called velocity, which is stored in files.

The scored transactions are sent to the appropriate output channels 214. Examples of supported output channels 214 include, but are not limited to, ASA, Banknet, DataCollector, Case Management, and the Initialization and Modeling database. For the ASA output channel, scores are returned to the ASA for inclusion in the 0100 authorization request that is sent to the issuer. For the Data Collector output channel, transactions are stored to the database where they are used for various reporting and billing purposes. In addition, the data collector monitors the system Service Level Agreements (SLA) such as the time to score a transaction For the Case Management output channel, transactions which exceed a threshold are sent to a Case Management system. In addition, transactions are stored in a database for future initialization and modeling.

Still referring to FIG. 4, a business support analyst has access to at least two online web applications 240. At least one online web application 240 may be a customer extranet. First, an administration web application 242 is used to configure the decision platform 200. The system 200 allows the configuration of customers, card bin ranges, scoring models, input and output channels, thresholds, and billing rates. The reporting web application 244 provides scoring analytics which can be used to analyze performance as well as to provide visibility into the system operation and billing. A technical support analyst is able to access the administration web application 242, reporting web application 244, and Case Management application 246 online web applications as well as the operations monitoring and dashboard 250.

Customers are able to access the decision platform administration web application 242, reporting web application 244, and Case Management application 246 through a Customer Portal 252. The Customer Portal 252 is exposed via an online web application 240.

The above described platform scores real time transactions within low latency targets and is able to readily scale for increasing transaction volumes. In addition, model creation and customer boarding times are minimized. While performance is critical, the highest performance is achieved with minimal impact to the maintainability of the system. The scoring platform is an open architecture featuring loosely coupled, pluggable, highly configurable components while readily supporting new input and output channels as well as new scoring engines. The framework for supporting the administration, licensing, billing, monitoring, and reporting functions readily supports such flexibility.

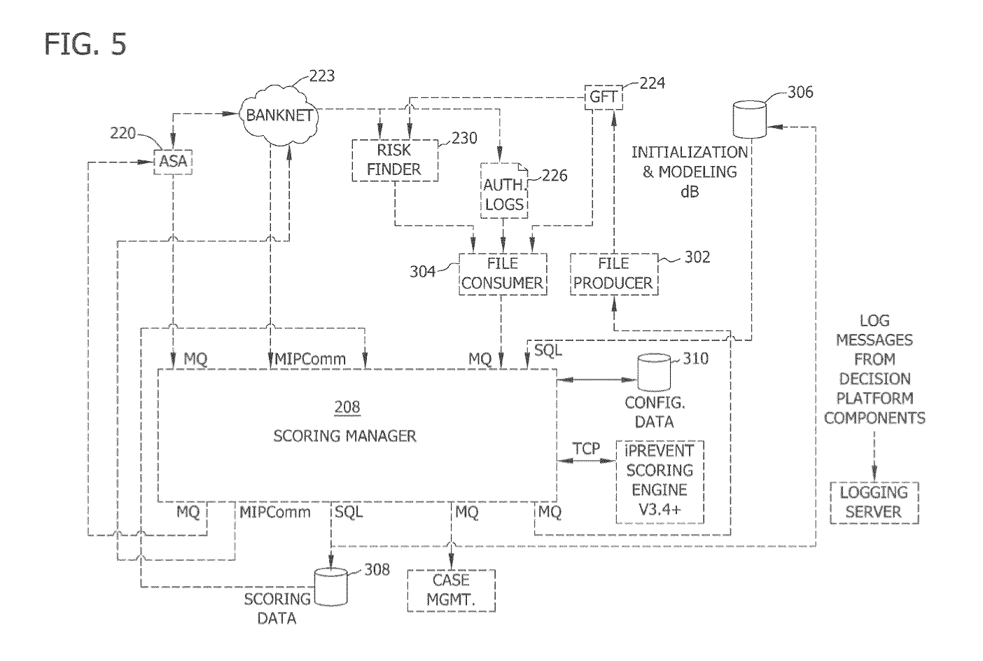

FIG. 5 is a diagram illustrating a logical architecture 300 for the above described decision system 200 where common components are illustrated with the same reference number as used in previous figures. The logical architecture 300 features a scoring manager 208 which is responsible for processing the transactions. The scoring manager 208 receives transactions from a variety of input channels which include the ASA 220, Banknet 223, and Databases. The ASA 220 sends transactions directly to the scoring manager 208 via IBM WebSphere MQ (MQ). Customers' transactions are sent to the scoring manager 208 via Banknet 222. The File Consumer 302 reads transactions from files and delivers these transactions to the scoring manager 208 via MQ.

The scoring manager 208 listens on the input channels 202 via configurable adaptors. For example, ASA Input Adaptor establishes a listener on MQ Queue connection to receive 0100 scoring request messages. The transactions received from the input channels 202 are then processed using a flexible combination of transformations, filtering, and enrichment including scoring of the transactions using, for a non-limiting example, the iLog jRules. The processing results are delivered via a variety of output channels 214 which include MQ message to the ASA.

The scoring manager 208 includes a highly flexible transaction processor that is driven by database Configuration Data 310 and plug-in components. Table 1 includes an example execution plan for an example account that is in the bin range of customer A.

TABLE 1

| | Component | Name | Customer Parameters |
|---|---|---|---|
| 1 | Transform | CIS 0100 | |
| 2 | Filter | Duplicate Check | |
| | | (fail = skip to 7) | |
| 3 | Filter | MCC Filter | MCC = 1234, 2345, 2341 |
| | | (fail = skip to 7 | |
| 4 | Enrichment | Issuer Country Code | |
| 5 | Enrichment | iLogj Rules | Model = CustomerAA |
| 6 | Output | ASA | |
| 7 | Output | Scoring Data Collector | |
| 8 | Output | Performance Data Collector | |

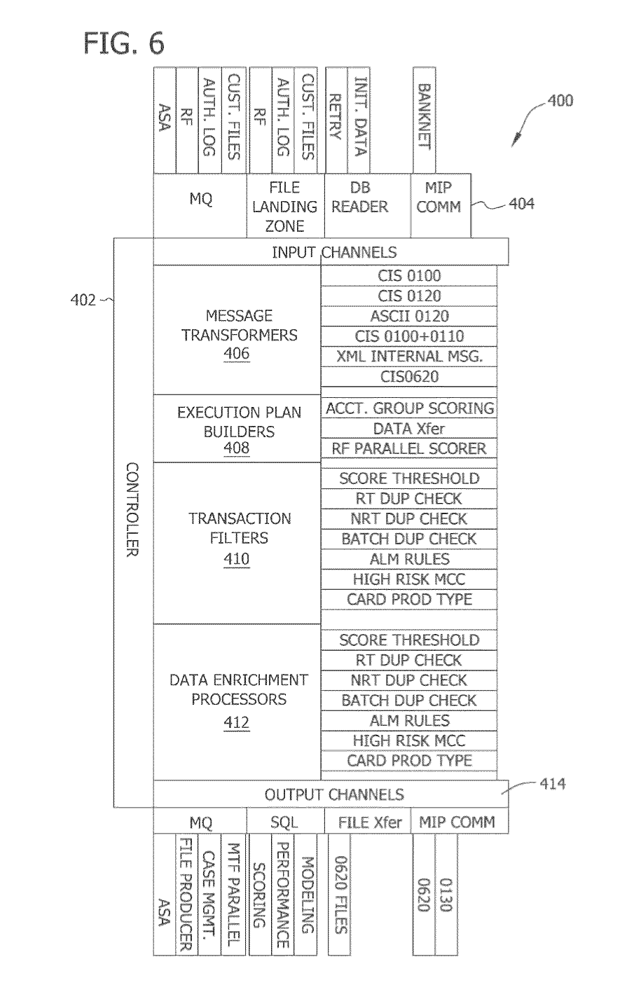

FIG. 6 is a logical architecture diagram for a flexible transaction processor (FlexTP) 400 that is utilized in the decision platform of FIG. 4. The main components of the flexible transaction processor 400 are the controller 402, input channel adaptors 404, message transformers 406, execution plan builders 408, transaction filters 410, data enrichment processors 412, and output channel adaptors 414. The flexible transaction processor 400 features a component plug-in architecture to provide a highly configurable transaction processor. The plug-ins can be added or changed at run time. In one specific implementation, plug-ins are written to be thread-safe so that multiple instances of a plug-in do not need to be constructed to save execution time.

The controller 402 is configured to control the execution of the FlexTP 400, which allows fraud prevention rules to be written based upon variables in a transaction and can either score and/or block the transaction that meet the criteria. At startup, the controller 402 logs a start up message to a logging server (not shown). The controller 402 then launches the configured plug-ins for the input channel adaptor 404. The number of threads and priority of each adaptor 404 is configurable. The input channel adaptor 404 receives transactions from the configured input channel, creates an internal message to hold the unparsed transaction and input channel information which is then returned to the controller 402.

If the input message type is configured for a transformation, the controller 402 invokes the Transform Service (message transformers 406) with an internal message object and the configured transformation type. The message transformers 406 looks up the appropriate transformation plug-in and uses the plug-in to create the appropriate parsed transaction data object (e.g., 0100), includes this parsed transaction data object in the internal message object and returns the internal message object to the controller 402. The controller 402 then invokes the execution plan builders 408 with the configured builder name and the internal message object. The execution plan builder 408 looks up the appropriate builder plug-in and uses it to create an execution plan for the transaction. The execution plan builder 408 then includes the execution plan in the internal message object and returns it to the controller 402. If the transaction fails the message transformation or the execution plan building, the controller 402 executes the configured failure execution plan.

Using this execution plan, the controller 402 then invokes the specified transformations, transaction filters 410, enrichment processors 412 (including scoring engines), and output delivery channels 414 as specified by the execution plan. For each part of the process, the controller 402 passes the internal message object and the appropriate configurations to the component service. The component service looks up the appropriate plug-in and uses it to perform the appropriate processing, includes any new or altered data in the internal message object, and returns it to the controller 402. Each component returns an indication of its success or failure which is used by the controller 402 to manage the execution of the message. If the controller 402 receives an error at any point of the processing, it should execute the failure execution plan for that point. If any transaction filter 410 does not pass, the controller 402 executes the filter alternate flow instead of the planned execution flow.

In one embodiment, the controller 402 executes all tasks sequentially. In alternative embodiments, the controller 402 includes a capability to process some tasks in parallel. This “parallel processing” is accomplished using separate worker threads for each parallel task and waiting for all tasks to complete prior to continuing.

When properly configured, the controller 402 executes within a unit of work. For example, the entire set of processing from accepting a transaction from an input channel adaptor 404 through to delivery to an output delivery channel 414 should be performed within the same transactional unit of work. If any problems are encountered, the unit of work is rolled back. This capability is required for transaction flows that require 100% processing without dropping any transactions in the event of a failure. While this might result in some transactions going through part of the processing twice, this insures that all transactions are successfully processed.

The controller 402 also provides an ability to gracefully shutdown. To accomplish such a shutdown, all threads should complete their unit of work and not start processing any new transactions. When all threads have completed their processing, the controller 402 logs a shut down message and ends the processing.

Any errors not specific to a single transaction are logged via the above mentioned logging server (not shown in FIG. 6). Errors isolated to a single transaction (e.g., missing data required for scoring), are included in the execution plan status for the appropriate point. If configured, the data collector output channel 214 (shown in FIG. 4) will save this information to the database.

In one specific embodiment, the controller 402 is implemented as a daemon process, and periodically polls its configurations. If any changes are detected, it reconfigures as appropriate and logs an information message. Also, the controller 402 listens on a control command queue using an MQ input adaptor.

The following control commands are supported: graceful shutdown request, forced shutdown request, pause request, resume request and log thread status. In regard to a graceful shutdown request, after each thread is finished with processing the current transaction, the controller should stop the thread. When all threads are stopped, the controller 402 shuts down. For a forced shutdown request, the controller 402 interrupts any processing threads and shuts down immediately. For a pause request, after each thread is finished with processing the current transaction, it should pause until a resume request is received. For a resume request, the processing of any paused threads is resumed. For log thread status, the controller 402 logs information about how many threads are running, their priority, status, etc.

Plug-ins associated with the input channel adaptor 404 are used to receive transactions. Abstract input channel protocol adaptors are defined, as shown in FIG. 6, to support MQ listeners, file input landing zones, and database readers. These abstract protocol adaptors provide helper methods for interacting with the specific protocol. They are extended by input channel adaptor plug-ins (e.g., ASA MQ Input Adaptor) which provide an ability to identify the specific input channel messages and create the internal message object which includes the appropriate input channel information as well as the unparsed transaction data. Each input channel adaptor listens on the specific input channel for transactions, constructs an internal message object to hold each transaction, and passes the internal message to the controller 402 for processing. A log message is generated and sent to the logging server for appropriate events such as startup/shutdown of the listener, any messages returned by the adaptor at startup and shutdown, or any non-transaction specific errors.

The MQ listener input channel establishes the configured number of threads as listeners on the configured MQ Queue Name and Queue Manager Name. The MQ header information is included in the internal message as input channel specific information. This includes the reply to queue and queue manager name. If the internal message cannot establish itself as a MQ listener or failures stop it from listening, it will attempt to reestablish itself as a listener. If unsuccessful, it will periodically reattempt after waiting a configurable interval. The MQ message is passed to an abstract method which returns an Internal Message object. This method is implemented by each plug-in, including the ASA plug-in, the RF plug-in, the authorization logs plug-ins, the customer files plug-in, and the control command plug-in.

If the files do pass these checks, a record of the file is added to the processed files database table. In one embodiment, this database table includes a filename, a file creation date/time (e.g., when it was received from GFT), a customer ID, a path name, a file status (processing, duplicate, filtered out, completed, error), a processing start time, a processing end time, a listener name, a consumer name, a transaction count, a last checkpoint ID, and a last checkpoint timestamp.

Each transaction is then read from the file and sent to the controller 402. The listener is configured, in one embodiment, to ignore any header or trailer data in the file. The file name and any important information in the header/trailer is included in the input channel specific information in the internal message object on all transactions in the file. The process should implement a configurable throttle to control the rate at which messages are placed on the queue so as to not swamp the system. After processing all transactions in a file, the process updates the processed file record to indicate a successful processing of the file, and sends a log message to the logging server to indicate the file was successfully processed. In addition, a performance log message is sent which includes the file name, the number of transactions processed, the processing start time, and the processing end time.

With regard to the database reader input channel, this listener is configured to periodically execute a configured query against a database at a specified interval. The query returns a set of transactions which are then sent individually to the controller 402. The database reader input channel keeps track of which transactions have been successfully processed and which are able to recover from a failure. To accomplish this transaction monitoring, the result set is limited to a configurable amount and a configurable throttle (e.g., a wait time) is used. The query is ordered by date/time and a checkpoint row ID is saved after each block of transactions is processed. For the database reader input channel, the following plug-ins are supported in one embodiment, and include an initialization data loader plug-in, a retry data plug-in, and an MTF parallel score.

With regard to message transformers 406, a message transform service accepts an internal message object and a transformation type. The service looks up the specified transformation plug-in and uses it to create a new transaction. The message transformations use a plug-in design, and transformation plug-ins conforming to the transformation API will be developed. The following transformation plug-ins have been developed and include ASA ES Request with CIS0100, and XML Internal Format.

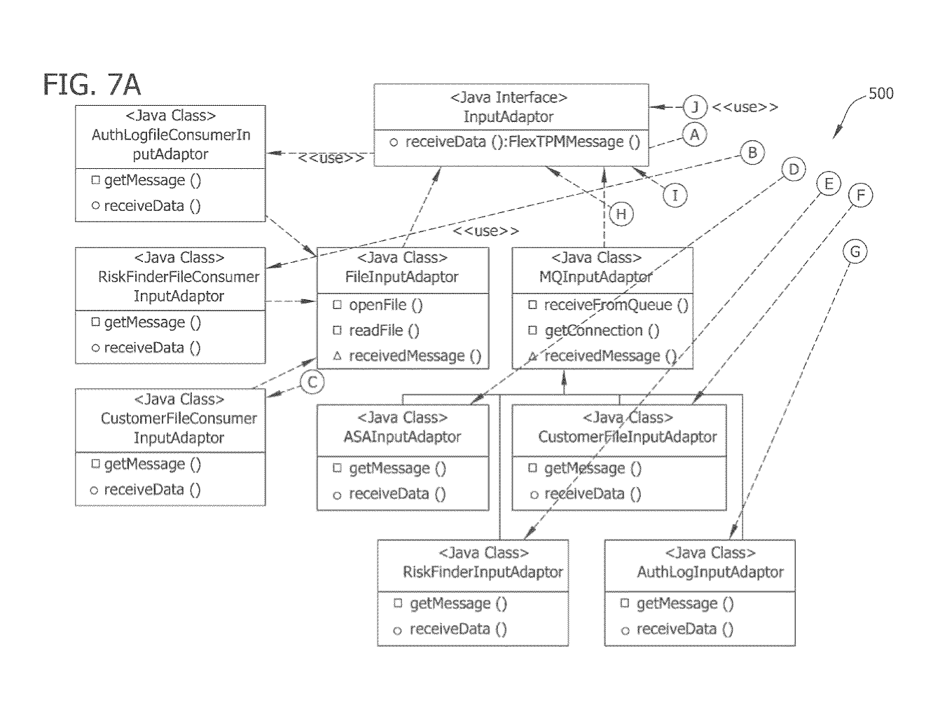

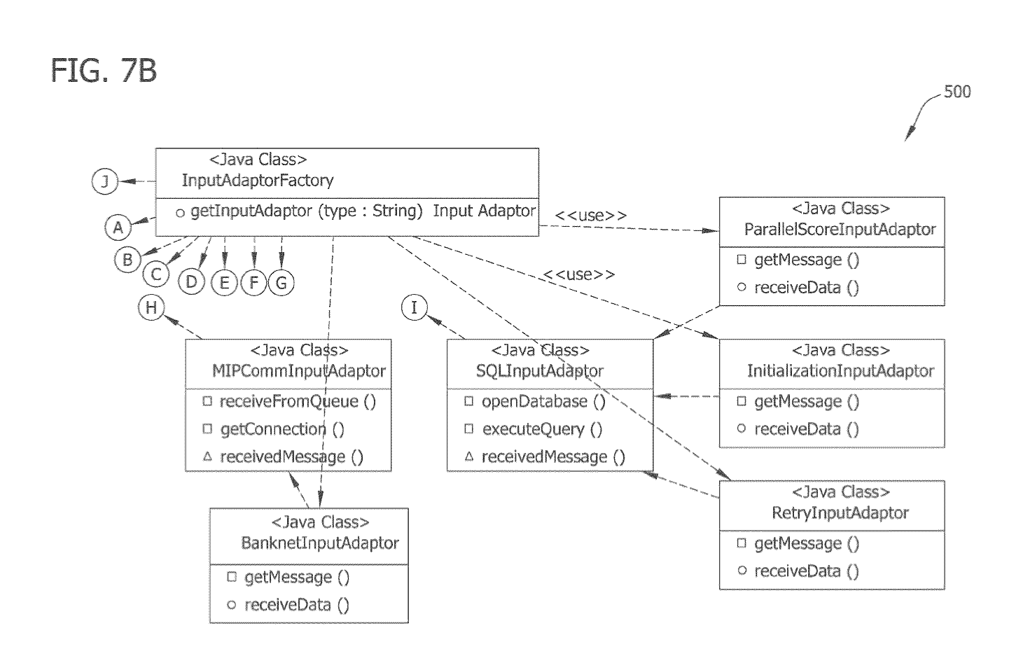

FIGS. 7A and 7B are a class structure diagram showing an embodiment of a class structure 500 for the input channels of the flexible transaction processor.

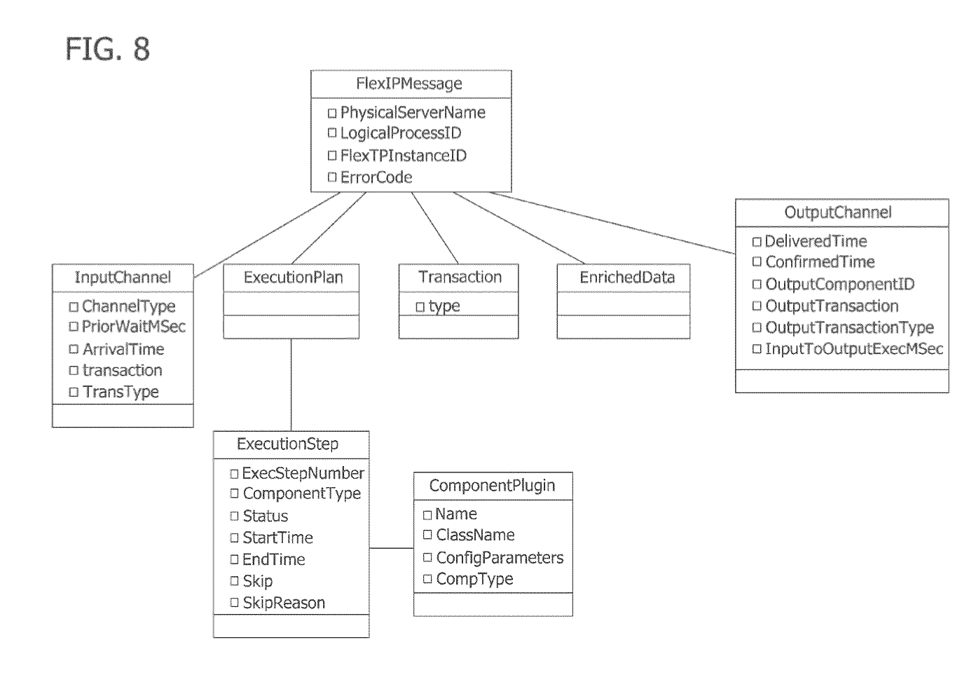

Referring to FIG. 8, and with regard to internal message formats, the FlexTP architecture of FIG. 6 uses the internal message object illustrated in FIG. 8 to pass messages between the components. In the illustrated embodiment, the FlexTP message object contains one input channel object that contains information about how the transaction arrived, one execution plan object that contains the tasks for processing the object, one to many transaction objects that contains the details of the transaction, one instrumentation object that contains instrumentation details on the relative to the processing instance, zero to many enriched data objects that contains enriched data, and zero to many output channel objects that contains information about resulting transactions sent to an output channel.

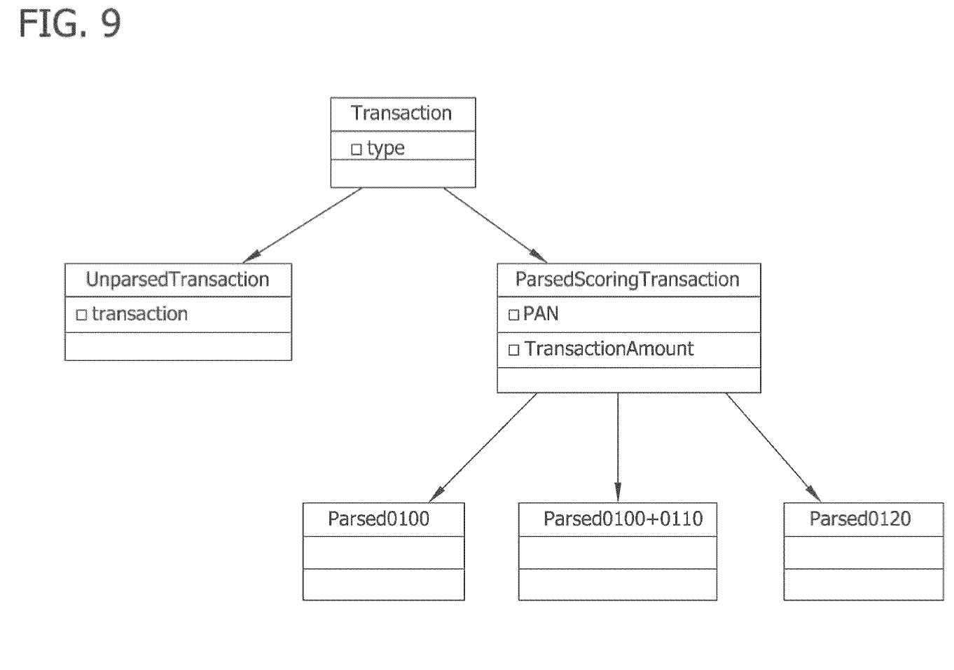

The Transaction object of FIG. 9 is an abstract class that can be sub-classed for any type of transaction. Subclasses have been developed that consist of UnparsedTransaction to hold any packed transaction and ParsedScoringTransaction for each of the expected input transactions (e.g., 0100).

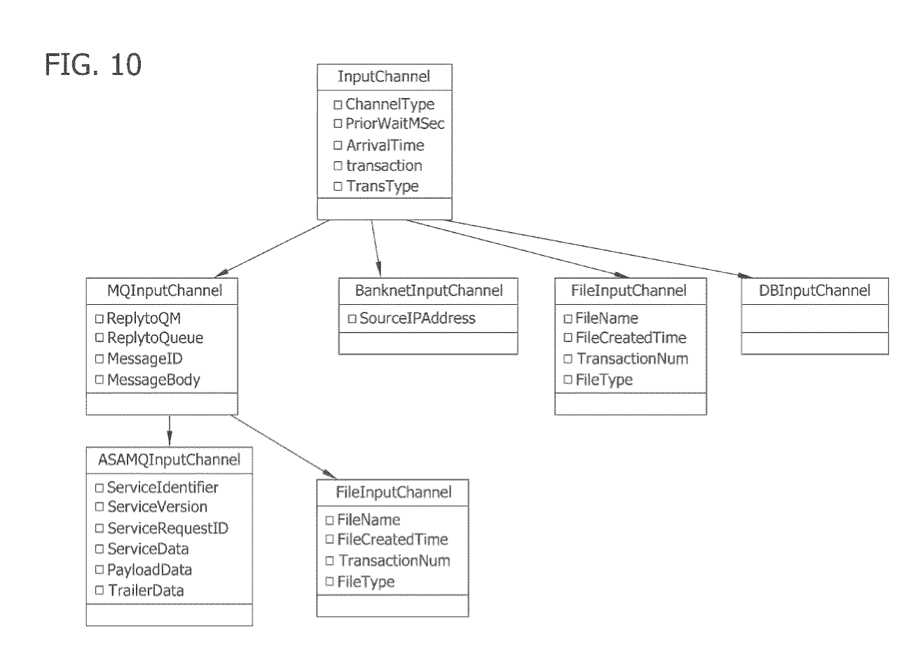

Now referring to FIG. 10, the InputChannel object is subclassed by specific input adaptors to hold protocol specific information as shown. An illustrated example is ASAMQinputChannel.

Execution plan builder plug-ins are defined to specify the execution plan for processing a transaction. These execution plans include the ordered set of tasks using the appropriate transaction filters, data enrichment processors, and output delivery channels. Each execution point includes a type (Transformer, Filter, Data Enrichment Processor, or Output Channel), a name (the component name), a plug-in class name (the actual class name of the plug-in), plug-in specific configuration parameters (which includes any configuration parameters such as a score filter threshold value), a failure resumption (if execution of the resumption fails, processing should resume at this point), and a filter resume task (if a components filter check does not pass, execution resumes at this task).

A standard scoring builder uses the transaction Primary Account Number (PAN) and input channel type to lookup the corresponding customer account group configurations established through the Admin system located in the Admin database. This configuration data is used to create the customer specific execution plan. In one embodiment, these configurations are cached in memory and refreshed at a configurable interval for improved performance.

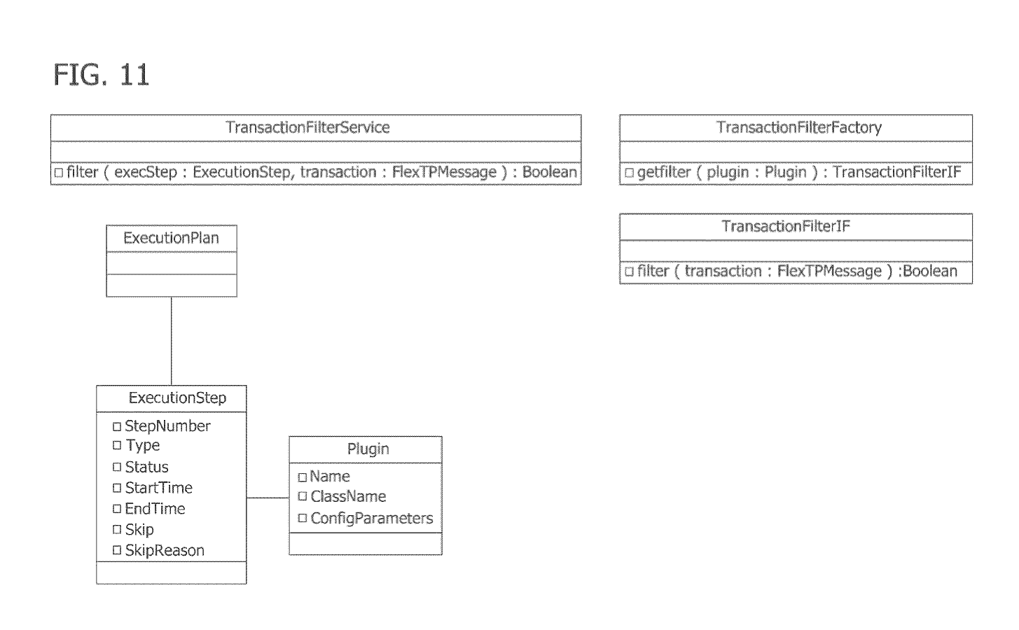

With regard to transaction filters 410, and referring to FIG. 11, the transaction filter service is invoked to filter a transaction using the configured plug-in for that execution point. For example, the transaction filter service uses a factory to retrieve an instance of the plug-in class that conforms to the transaction filter interface. The plug-ins are written to be thread-safe so that multiple instances of a plug-in do not need to be constructed to save execution time. The transaction filter plug-in class executes logic that analyzes the transaction data and returns a pass or fail indication to the controller 402. If the filter check passes, the controller 402 continues the execution plan at the next point. If the filter check fails, the controller 402 skips down to the configured execution.

An operational skip filter checks to see if any operation skips are configured that apply to this transaction. Operational skips can be defined using the Admin application and will consist of an account range to skip processing. A score threshold filter checks if the transaction score is below the supplied threshold parameter. If so, the transaction will skip delivery to the configured output channels (e.g., Banknet adaptor, batch file adaptor, etc.).

A duplicate check filter performs a check to see if the transaction has already been scored and, if so, applies the previous score to the transaction. This duplicate check filter is a function of the input channel. A real time 0100 ASA transactions filter determines if the transaction has an ES Status Code of ‘S’ indicating the transaction is going to stand-in and is a potential duplicate. If so, it will check the duplicate check queue to determine if the transaction has been already been processed. If so, the previous transaction score will be looked up in the scored transaction database and included in a Scoring Result object. The execution plan will be altered to skip the scoring. For all transactions going through the filter, an entry is added to the duplicate check queue consisting of the Banknet reference number with a message expiration time of 30 seconds.

A Merchant Category Code (MCC) filter determines if the transaction MCC code was in the customer specific list of MCC codes to be scored. It should be noted that filters may also return enriched data objects. For example, the duplicate check filter will return the previous scored in an enriched data object if the filter check does not pass (e.g., transaction is a duplicate).

With regard to data enrichment processors 412, such processors are defined as processors that enrich the transaction by adding new data or altering existing data. Each data enrichment processor 412 implements an API which consists of accepting the internal message. The processor alters the transaction data and includes new enriched data objects. The following paragraphs define several example data enrichment processors, including but not limited to an issuer country code, and an iLog jRules engine. Other data enrichment processors include, for example, a last response code, a compromised account indicator, one or more scoring engines, and a rules engine.

If the issuer country code is not supplied in the transaction, this data enrichment processor will determine the issuer country code based on the appropriate Auth Account Range.

Now referring to output channels 414, output channel adaptor plug-ins can be defined for delivering processed messages. These output channel adaptors accept an internal message and return an indication of whether the delivery was successful. Abstract protocol adaptors are defined to support MQ. These abstract protocol adaptors provide helper methods for interacting with the specific protocol. The MQ protocol adaptor provides methods for attaching to a configured queue and putting messages into the queue. Plug-ins can extend an abstract protocol adaptor to simplify the plug-in development. The following output channel adaptor plug-ins will be defined.

For an MQ ASA output channel adaptor plug-in, the ASA output adaptor will create an MQ message that contains the scoring and/or rule results. If the transaction should be blocked, the service status is set to ‘B’ for block. Otherwise, if the transaction was successfully scored, the actual score should be returned and the service status set to ‘C’ for complete. If the transaction was not successfully scored, the actual score should be left blank and the service status set to ‘E’ for error or Blank if the scoring was not attempted. The ASA time stamp in the ES request message trailer is returned in the ES response message trailer and is used by the ASA to measure the real time scoring system response time. This MQ message is delivered to the reply—to queue and queue manager from the input message.

For a SQL scoring data collector output channel adaptor plug-in, this adaptor saves the scored transaction to the database. In addition, it keeps track of summarized scoring results per account range. A performance data collector output channel adaptor plug-in calculates performance statistics including min, max, and average over pre-defined intervals (e.g., last 30 sec, 5 min, 1 hr, 2 hr, last day, last week, and the like) for overall real time processing, individual component processing times, TPS, and total number of transactions processed, and saves performance data to a database. In one embodiment, these statistics are calculated for the entire platform and per customer and should allow segregation by successfully scored vs. failed transactions. To save performance data to a database, warning messages are logged if performance is lower than pre-configured thresholds.

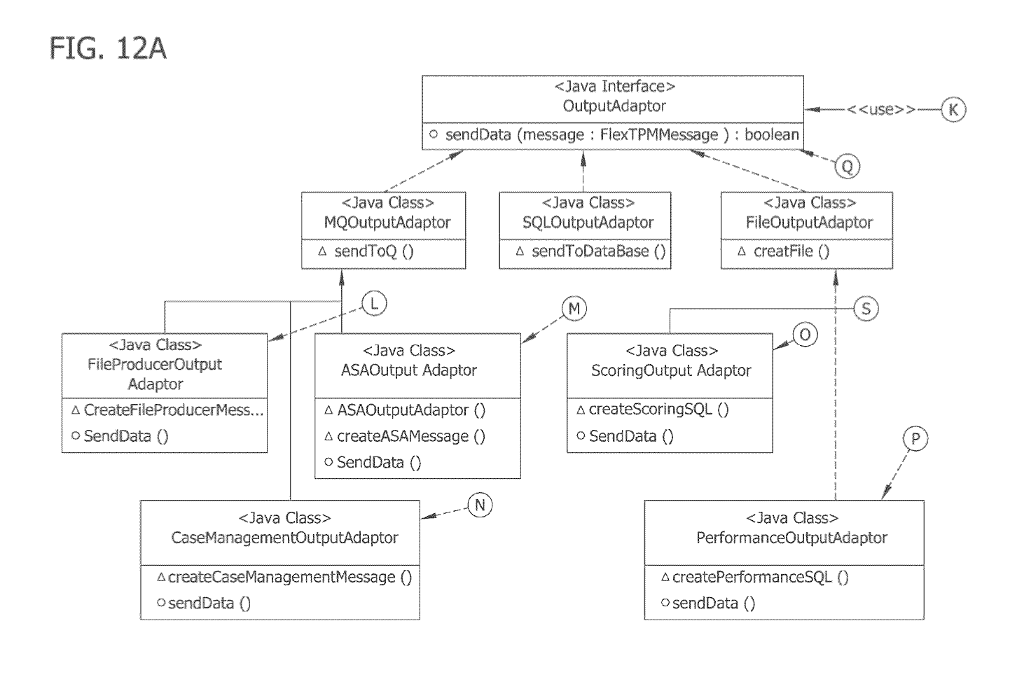

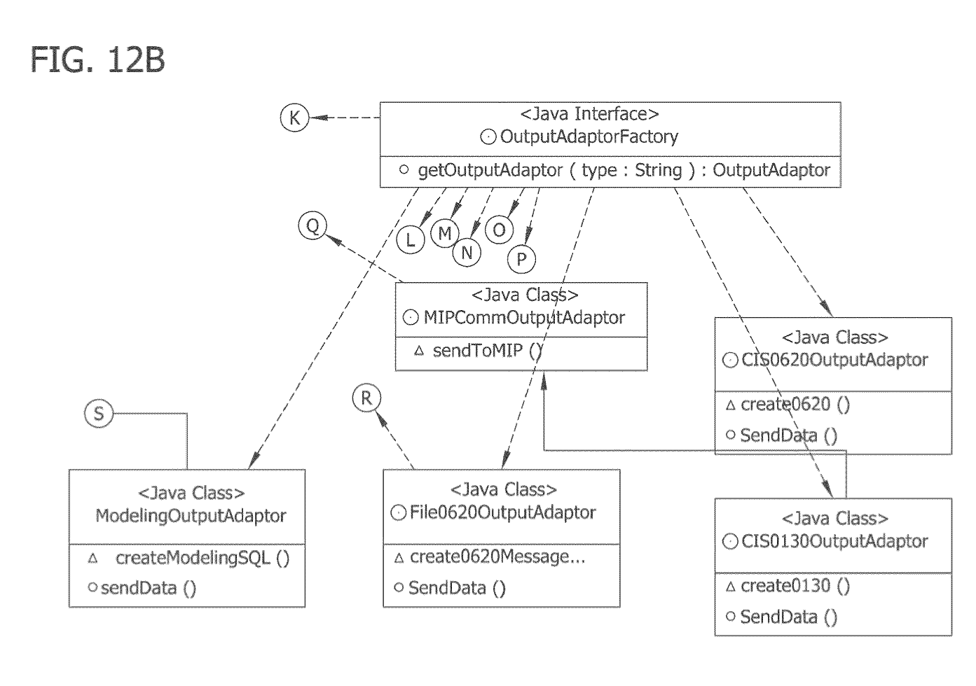

The output channels described above use the class structure illustrated in FIGS. 12A and 12B. Various technical platforms are used: including, Solaris 10, Sun Java 1.6, Log4J 1.2.x, WebSphere MQ V7.0.1, WebSphere MQ Application Messaging Interface for Java, Hibernate 3.1.3, and Spring 2.53.

In another embodiment, a computer and a computer program are provided which are configured or programmed to perform processes similar to those already recited herein.

The systems and processes described herein enable a user, such as an Automated Teller Machine card network, to take financial transaction data received from a variety of different input channels and pre-process the transaction data into a common data format. Data enrichment is provided to the commonly formatted transaction data, based on the user's position as operator of the network. Examples of data enrichment include indications as to whether or not the transaction cards were recently compromised and other augmenting data with information regarding which country the issuer of the card resides. Such enrichment and augmentation is used in part to orchestrate financial scoring of individual transactions.

Several products are available to do the financial scoring each of which incorporate fraud models and different artificial intelligent technologies to score the transactions. The described embodiments, in part, provide a mechanism to generate a financial scoring using multiple scoring products. Selection of which scoring products are used, and in which combinations, are determined by the used based on what scoring products they wish to offer to different customers, for example, a fraud score and/or a credit risk score. The embodiments describe an architecture that allows a user to plug in different scoring models and then score transactions using single scoring products or multiple combination of multiple scoring products to provide value added services to, for example, customers of the above mentioned Automated Teller Machine card network.

The embodiments allow the user to easily integrate, for example, multiple vendor scoring products, while also orchestrating scoring across many of the scoring products. The architecture combines the scores and returns those scores back to customers through the variety of output channels described above.

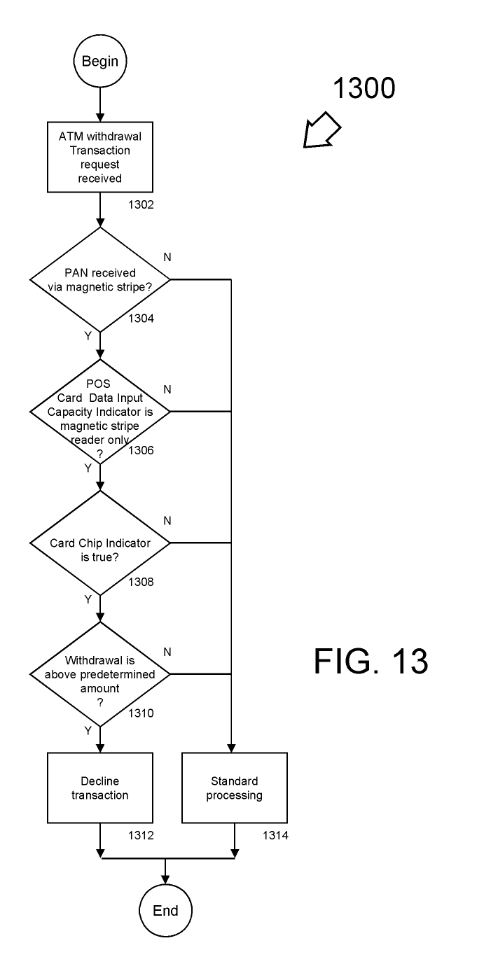

We now turn our attention to example fraud prevention rules adopted by controller 402 to block transactions as illustrated in FIGS. 13-15. In these examples, the rules assume that the ATM transaction is a cross-regional ATM transaction, although it is understood by those familiar with the art that fraud prevention rules may also be applied within a region.

FIG. 13 illustrates a fraud prevention rule 1300 in which a withdrawal is prevented because the transaction amount exceeds a predetermined amount.

At block 1302, decision platform 200 receives an ATM withdrawal transaction request from merchant bank 26. The withdrawal transaction request is received electronically via a network interface.

The ATM transaction request contains information such as the amount of the withdrawal and a Primary Account Number associated with the ATM card, a Card Data Input Capacity Indicator, and a Chip Card Indicator. This data is referred to as ATM transaction data. Additional ATM transaction data may include: Name of card holder, Account number, Card Expiration date, and a security code (such as a Card Verification Value or “CW” code).

The Primary Account Number is a unique number commonly embossed or imprinted on the prepaid card, and a magnetic stripe on the back of the card contains the data in machine readable format.

The Card Data Input Capacity Indicator indicates how the PAN was received by the ATM. The PAN may be received via a myriad of different ways from the ATM-most commonly via a magnetic stripe encoded on the back of the ATM card, via a computer chip embedded within the card (such cards are referred to as “chip cards”), via Near Field Communication (NFC), or contactless communication of the PAN such as PayPass® (PayPass is a registered trademark of MasterCard International Incorporated, Purchase, N.Y.).

A Chip Card indicator indicates whether the ATM card has a computer chip within the card.

If the PAN was received via a magnetic stripe, block 1304, the point-of-sale card data input capacity indicator is magnetic stripe only, block 1306, the card chip indicator is true, block 1308, and the requested withdrawal exceeds a predetermined amount, block 1310, then the transaction is declined without consulting the issuer bank 30, block 1312. For example, a typical predetermined amount would be US $500. It is understood by those familiar with the art that the predetermined amount may vary from user to user. As part of the decline, the response code is set to “Do not honor” and the transaction blocking reason code is set to “Declined due to high value.” In some embodiments, the issuer is informed of the pre-emptive decline performed on their behalf, via the network interface. In other embodiments, ATM Acquirer can access the details of the transactions which were pre-emptively declined via the online web application 240. Otherwise, standard processing applies, block 1314.

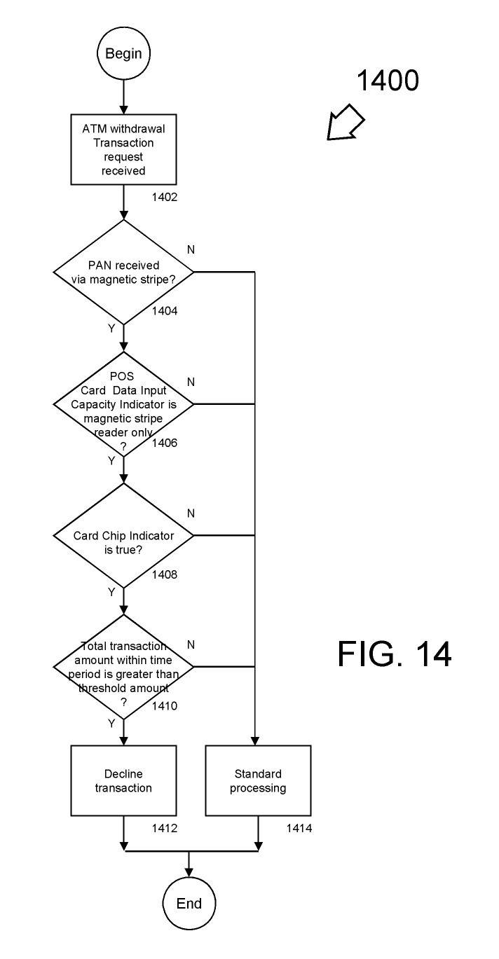

FIG. 14 illustrates a fraud prevention rule 1400 in which a withdrawal is prevented because total transaction amounts exceeds a predetermined amount within a time period.

At block 1402, decision platform 200 receives an ATM withdrawal transaction request from merchant bank 26. As mentioned above, the ATM transaction request typically contains information such as the amount of the withdrawal and a Primary Account Number associated with the ATM card, and how the PAN was received by the ATM.

If the PAN was received via a magnetic stripe, block 1404, the point-of-sale card data input capacity indicator is magnetic stripe only, block 1406, the card chip indicator is true, block 1408, and the total of requested withdrawals exceeds a predetermined amount within a given time period, block 410, then the transaction is declined without consulting the issuer bank 30, block 1412. The determination at block 1410 is typically made by comparing the transaction against a transaction history stored the user database 120. For example, a transaction may be declined because the total transaction amount within the last three days is greater than US $1,000. It is understood by those familiar with the art that the predetermined amount and specified time period may be varied to counteract predicted fraud. As part of the decline, the response code is set to “Do not honor” and the transaction blocking reason code is set to “Declined due to high value.” Otherwise, standard processing applies, block 1414.

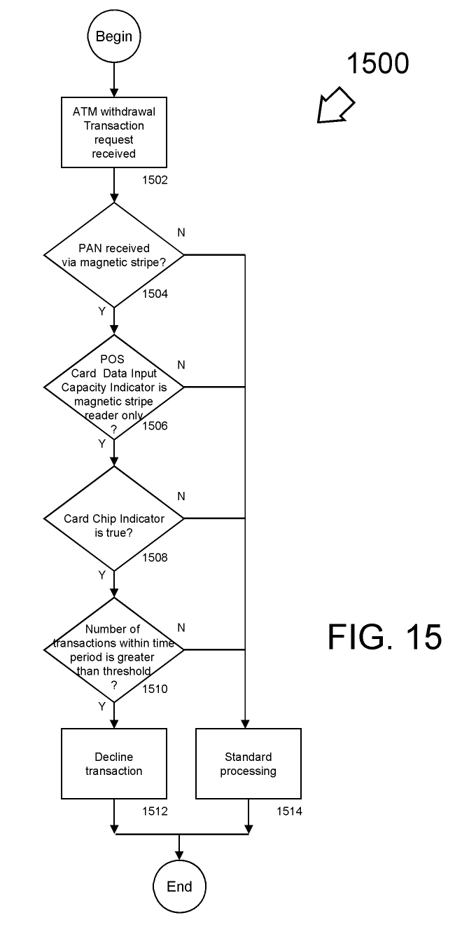

FIG. 15 illustrates a fraud prevention rule 1500 in which a withdrawal is prevented because the total number of transactions exceeds a predetermined amount within a time period.

At block 1502, decision platform 200 receives an ATM withdrawal transaction request from merchant bank 26. As mentioned above, the ATM transaction request typically contains information such as the amount of the withdrawal and a Primary Account Number associated with the ATM card, and how the PAN was received by the ATM.

If the PAN was received via a magnetic stripe, block 1504, the point-of-sale card data input capacity indicator is magnetic stripe only, block 1506, the card chip indicator is true, block 1508, and the total of number of withdrawals exceeds a predetermined amount within a given time period, block 1510, then the transaction is declined without consulting the issuer bank 30, block 1512. The determination at block 1510 is typically made by comparing the number of transactions in a transaction history stored the user database 120 within a set time period. For example, a transaction may be declined because the total number of transactions within the last three days is greater than five. It is understood by those familiar with the art that the predetermined amount and specified time period may be varied to counteract predicted fraud. As part of the decline, the response code is set to “Do not honor” and the transaction blocking reason code is set to “Declined due to high activity.” Otherwise, standard processing applies, block 1514.

With the ATM fraud prevention models and rules described above, if a cardholder uses an ATM that is determined to be high risk to conduct a financial transaction associated with his/her account, there is a potential chance for the transaction to be blocked. As a result, some transactions, which the issuers may not want to block (e.g., transactions by their premium cardholders), may actually be blocked by controller 402 if these transactions meet the blocking criteria of the fraud prevention models and rules, causing potential damage to the issuers' product brands especially among frequent cross-border travelers. Consequently, in one aspect of the disclosure issuers are allowed to provide a “white list,” which is a list of accounts of cardholders who are traveling abroad, to ensure that their ATM transactions will not be blocked, and to prohibit issuers from requesting fraud-related chargebacks for transactions associated with these unblocked accounts listed on the white list.

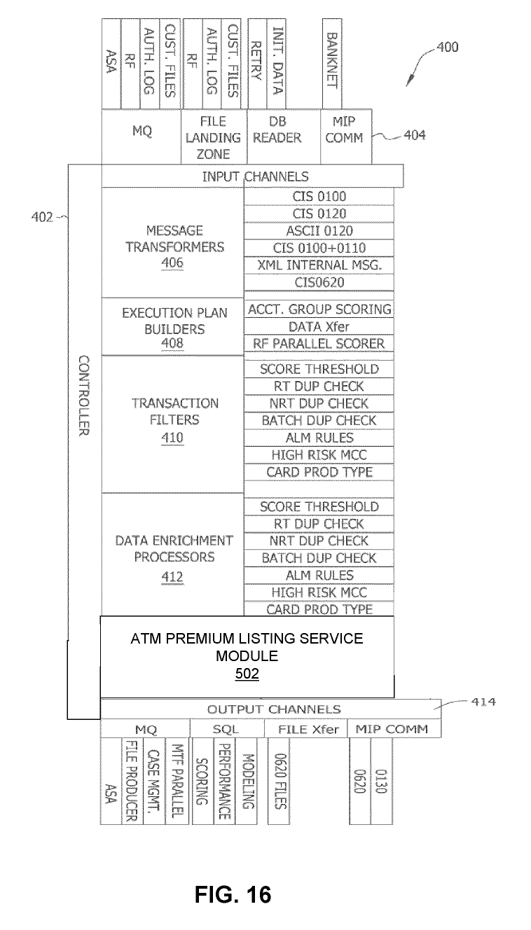

A new ATM premium listing service module 502 associated with controller 402 as shown in FIG. 16 is provided that allows issuers to register accounts of their cardholders to ensure that ATM transactions initiated by a cardholder of an account included in an ATM premium list are not blocked by controller 402 based on the fraud prevention models and rules for ATM transactions. In some embodiments, the ATM premium listing service module 502 provides the issuers with an option to choose to include a PAN associated with an account in the list to ensure that ATM transactions from the account of the PAN are not blocked by any ATM fraud prevention models and rules. This service will also prohibit the issuers from submitting fraud-related chargebacks for the PAN on the ATM premium list.

In some embodiments, the ATM premium listing service module 502 enables participating issuers to manually submit a list of accounts to be included in the ATM premium list so that transactions related to these accounts will not be blocked. In some embodiments, the list may include accounts of VIP cardholders or other exception profile travelers of the issuers. The ATM premium list can be stored and updated periodically (e.g., hourly) by the ATM premium listing service module 502 to reflect the latest submission and changes to the list made by the issuers. In addition, the ATM premium listing service module 502 also periodically retrieves lists of accounts from fraud prevention services that the issuers participate in, wherein such services include but are not limited to in Control services such as Fraud Control and Fraud Shield for the Frequent Traveler. In some embodiments, the lists from the fraud prevention services can be retrieved automatically by the ATM premium listing service module 502 from a data warehouse of the issuers to update the ATM premium list periodically (e.g., at least once a day). Once both the issuer-submitted list and the fraud prevention services' list have been retrieved, the ATM premium listing service module 502 will consolidate the two lists into one ATM premium list for unblocking the transactions associated with accounts on the list.

In some embodiments, the ATM premium listing service module 502 may create the ATM premium list via a User Defined Table (UDT)/User Defined List (UDL). In some embodiments, the initial list may be created in the form of a file. Once the initial ATM premium list is built, any future updates to the list can be done incrementally where any new submission is added to the list as a delta to the accounts already on the list.

In some embodiments, the ATM premium listing service module 502 enables the participating issuers to submit the list of PANs of the accounts to be included in the ATM premium list via a file update request (e.g., as a value in the file update request) submitted as a message, in a batch/bulk of messages, or via a web-based updating service online (e.g., eService, or NICS™) In some embodiments, data of the cardholders of these accounts other than their PANs may also be submitted.

Once a cardholder account number has been submitted to the ATM premium listing service module 502 and added to the ATM premium list, an issuer will have to explicitly submit a deletion request to the ATM premium listing service module 502 in order to have the account removed from the list.

In some embodiments, the ATM premium listing service module 502 manages the premium list and makes the list available to controller 402, which performs rule-based fraud prevention. During its operation, controller 402 will accept the ATM premium list from the ATM premium listing service module 502 and will not block any ATM transactions associated with accounts listed in the ATM premium list even if such transactions would have been blocked otherwise based on the ATM fraud prevention models and rules. In some embodiments, the ATM premium listing service module 502 may assign a unique code (e.g., 1 two-character reasoning code) to identify those transactions unblocked by controller 402 because they are on the ATM premium list.

Since transactions associated with the accounts in the ATM premium list provided by the issuers will not be blocked by controller 402, the liability for any potential fraud related to these transactions is shifted to the issuers who will be responsible for any potential fraud associated with authorizing the unblocked transactions. Due to such liability shift, the ATM premium listing service module 502 does not allow the issuers to submit any fraud-related chargebacks associated with these unblocked ATM transactions. In some embodiments, the success of restricting the chargebacks depends upon the quality of the Banknet reference numbers used for the chargebacks related to the transactions, wherein each Banknet reference number is a primary key for matching the authorization back to a chargeback.

In some embodiments, the ATM premium listing service module 502 creates and maintains a list containing all transactions that are not blocked by controller 402 because their associated accounts are on the ATM premium list. Such list includes authorization information associated with each of the unblocked transactions and is saved in a data warehouse. The authorization information of the transactions can later be used by the clearing system to restrict and prevent the fraud-related chargebacks requested by the issuers on those transactions. For a non-limiting example, the list must include one or more of the following: PAN of the account of the transaction, Banknet reference number, date and settlement information of the transaction, and/or authorization ID Response for the transaction. In some embodiments, the ATM premium listing service module 502 may remove or purge a transaction from the transaction list if no chargeback is requested by an issuer for the transaction beyond a certain period of time (e.g., after 120 days).

In some embodiments, the ATM premium listing service module 502 may bill for listing the accounts in ATM premium list for various fees and services related to the transactions associated with the accounts. For a non-limiting example, such fees can be maintenance fees for the premium list (e.g., adding, updating, and deleting accounts from the list) and residency fees based on pricings for premium services. Note that accounts retrieved from the fraud prevention services of the participating issuers will not be billed by the ATM premium listing service module 502.

In some embodiments, the ATM premium listing service module 502 provides the ability for dispute resolution management (DRM) by providing an indicator of a dispute that is related to a transaction not blocked by controller 402 because the transaction is associated with an account on the ATM premium list. Such indicator can be utilized by the dispute resolution team to identify and review any disputes that may be submitted for the transactions that were not blocked via web-based interface.

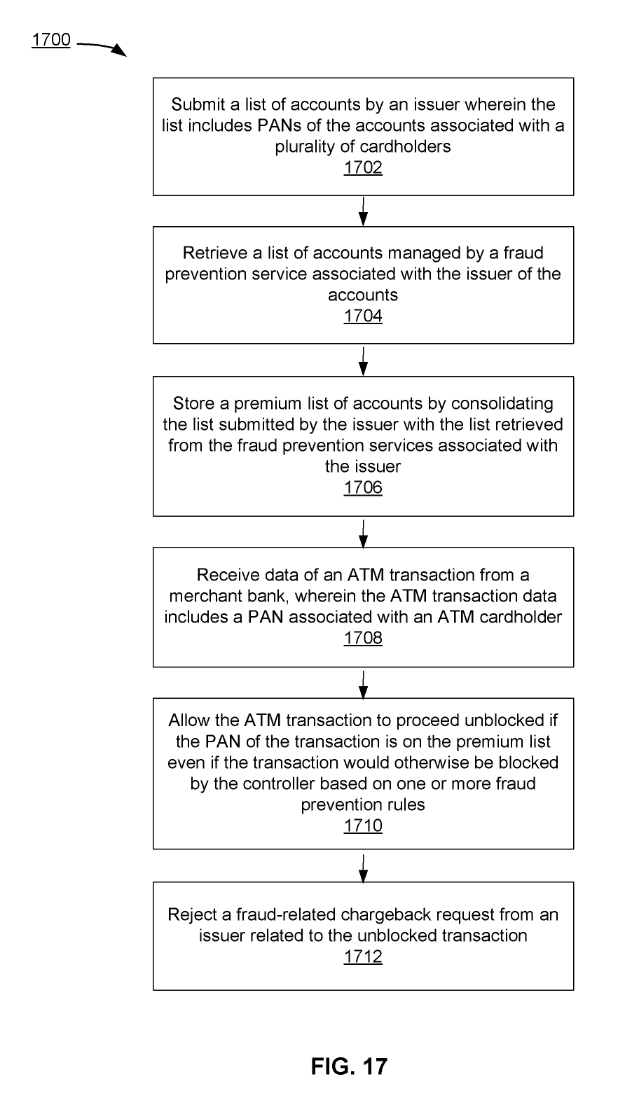

FIG. 17 illustrates an example of process 1700 to unblock ATM transactions based on a premium list of accounts of cardholders.

At block 1702, a list of accounts is submitted to ATM premium listing service module 502 by an issuer wherein the list includes PANs of the accounts associated with a plurality of cardholders. In addition, a list of accounts managed by a fraud prevention service associated with the issuer of the accounts may also be retrieved by ATM premium listing service module 502 at block 1704. Once both lists are obtained, ATM premium listing service module 502 forms and stores a premium list of accounts at block 1706 by consolidating the list submitted by the issuer with the list retrieved from the fraud prevention services associated with the issuer. At block 1708, data of an ATM transaction from a merchant bank is received, wherein the ATM transaction data includes a PAN associated with an ATM cardholder. Controller 402 allows the ATM transaction to proceed unblocked at block 1710 if the PAN of the transaction is on the premium list even if the transaction would otherwise be blocked by controller 402 based on one or more fraud prevention rules. Since the transaction is unblocked because its PAN is on the premium list, premium listing service module 502 will reject any fraud-related chargeback request from an issuer related to the unblocked transaction at block 1712.

It is understood by those familiar with the art that the system described herein may be implemented in hardware, firmware, or software encoded on a non-transitory computer-readable storage medium.

The previous description of the embodiments is provided to enable any person skilled in the art to practice the disclosure. The various modifications to these embodiments will be readily apparent to those skilled in the art, and the generic principles defined herein may be applied to other embodiments without the use of inventive faculty. Thus, the present disclosure is not intended to be limited to the embodiments shown herein, but is to be accorded the widest scope consistent with the principles and novel features disclosed herein.

What is claimed is:

1. A system comprising:
an automated teller machine configured to perform withdrawal transactions, the automated teller machine receiving a particular withdrawal transaction request including a particular account number and;
a fraud prevention mechanism applying one or more fraud prevention rules to the particular withdrawal transaction request;
a premium list of account numbers stored in a database; and
an electronic processor
determining whether the particular account number is in the premium list of account numbers,
causing the automated teller machine to reject the particular withdrawal transaction request if the particular withdrawal transaction request violates the one or more fraud prevention rules and the particular account number is not in the premium list of account numbers, and
causing the automated teller machine to fulfill the particular withdrawal transaction request if the particular withdrawal transaction request violates the one or more fraud prevention rules and the particular account number is in the premium list of account numbers.

2. The system of claim 1, wherein the automated teller machine is an improvised automated teller machine.

3. The system of claim 2, wherein the improvised automated teller machine is a card terminal of a merchant configured to provide at least some features of a conventional automated teller machine.

4. The system of claim 1, wherein the particular withdrawal transaction request includes presentation of a physical card issued by a particular financial institution, and the premium list of account numbers is provided by the particular financial institution.

5. The system of claim 1, further including the electronic processor rejecting a fraud-related chargeback request resulting from allowing the automated teller machine to fulfill the particular withdrawal transaction.

6. The system of claim 1, further including the electronic processor identifying the allowed particular withdrawal transaction request with an indicator for dispute resolution and clearance.

7. A system comprising:
an automated teller machine configured to perform withdrawal transactions, the automated teller machine receiving a particular withdrawal transaction request including a particular account number;
a fraud prevention mechanism applying one or more fraud prevention rules to determine a particular fraud risk for the particular withdrawal transaction request;
a premium list of account numbers stored in a database; and
an electronic processor
determining whether the particular account number is in the premium list of account numbers,
causing the automated teller machine to reject the particular withdrawal transaction request if the particular fraud risk exceeds a fraud risk threshold and the particular account number is not in the premium list of account numbers, and
causing the automated teller machine to fulfill the particular withdrawal transaction request despite the particular fraud risk if the particular fraud risk exceeds the fraud risk threshold and the particular account number is in the premium list of account numbers.

8. The system of claim 7, wherein the automated teller machine is an improvised automated teller machine.

9. The system of claim 8, wherein the improvised automated teller machine is a card terminal of a merchant configured to provide at least some features of a conventional automated teller machine.

10. The system of claim 7, wherein the particular withdrawal transaction request includes presentation of a physical card issued by a particular financial institution, and the premium list of account numbers is provided by the particular financial institution.

11. The system of claim 7, wherein the particular fraud risk is expressed as a particular fraud score, and the fraud risk threshold is a fraud score threshold.

12. The system of claim 11, wherein the fraud prevention mechanism includes a plurality of scoring engines, with each scoring engine providing fraud information to a scoring manager, and the scoring manager using the fraud information to determine the particular fraud score.

13. The system of claim 7, further including the electronic processor rejecting a fraud-related chargeback request resulting from allowing the automated teller machine to fulfill the particular withdrawal transaction.

14. The system of claim 7, further including the electronic processor identifying the allowed particular withdrawal transaction request with an indicator for dispute resolution and clearance.

15. A system comprising:
an automated teller machine configured to perform withdrawal transactions, the automated teller machine receiving a particular withdrawal transaction request including a particular account number;
a fraud prevention mechanism applying a set of fraud prevention rules to determine a particular fraud score for the particular withdrawal transaction request;
a premium list of account numbers stored in a database; and
an electronic processor
receiving the particular account number and the particular fraud score for the particular withdrawal transaction request,
accessing the premium list of account numbers,
determining whether the particular account number is in the premium list of account numbers,
causing the automated teller machine to reject the particular withdrawal transaction request if the particular fraud score exceeds a fraud score threshold and the particular account number is not in the premium list of account numbers, and
causing the automated teller machine to fulfill the particular withdrawal transaction request despite the particular fraud score if the particular fraud score exceeds the fraud score threshold and the particular account number is in the premium list of account numbers.

16. The system of claim 15, wherein the automated teller machine is an improvised automated teller machine, and the improvised teller machine is a card terminal of a merchant configured to provide at least some features of a conventional automated teller machine.

17. The system of claim 15, wherein the particular withdrawal transaction request includes presentation of a physical card issued by a particular financial institution, and the premium list of account numbers is provided by the particular financial institution.

18. The system of claim 15, wherein the fraud prevention mechanism includes a plurality of scoring engines, with each scoring engine providing fraud information to a scoring manager, and the scoring manager using the fraud information to determine the particular fraud score.

19. The system of claim 15, further including the electronic processor rejecting a fraud-related chargeback request resulting from allowing the automated teller machine to fulfill the particular withdrawal transaction.

20. The system of claim 15, further including the electronic processor identifying the allowed particular withdrawal transaction request with an indicator for dispute resolution and clearance.
